(19) United States
(12) Patent Application Publication
(10) Pub. No.: US 2020/0070189 A1
(43) Pub. Date: Mar. 5, 2020

(54) ADAPTER MIXER ATTACHMENT

(71) Applicant: NORDSON CORPORATION, WESTLAKE, OH (US)

(72) Inventor: Matthew E. Pappalardo, Ewing, NJ (US)

(21) Appl. No.: 16/539,457

(22) Filed: Aug. 13, 2019

Related U.S. Application Data
(60) Provisional application No. 62/725,000, filed on Aug. 30, 2018.

(51) Int. Cl. B05B 7/04; B65D 83/00

(52) U.S. Cl. CPC B05B 7/0408; B65D 83/0072

(57) ABSTRACT

An adapter couples to a single component fluid dispenser. The adapter includes a cap section, a first outlet, a second outlet, and a coupling member. The cap section has a cap interior surface that defines a cap channel extending therethrough. The first outlet defines a first outlet channel extending therethrough that is in fluid communication with the cap channel. The second outlet defines a second outlet channel extending therethrough that is in fluid communication with the cap channel. The coupling member is configured to couple the adapter to a nozzle.

### CROSS REFERENCE TO RELATED APPLICATIONS

This application claims the benefit of U.S. Provisional Patent App. No. 62/725,000, filed Aug. 30, 2018, the disclosure of which is hereby incorporated by reference herein.

### TECHNICAL FIELD

This disclosure relates generally to a fluid dispensing system, and more particularly to a fluid dispensing system having an adapter mixer attachment.

### BACKGROUND

Dispensing systems are commonly used for dispensing one or more fluids from containers. For example, some dispensing systems use so-called “sausage pack” containers, which are flexible and collapsible fluid containers. This type of collapsible container is generally cylinder shaped, and includes a fluid enclosed by a flexible membrane. Collapsible containers are generally sealed until they are ready to be used, at which point it is necessary to puncture the membrane. As the fluid is extracted from the container, the membrane may collapse to occupy a smaller volume than when it was full.

In one current system, two component adhesives and other reactive materials are contained and transported in solid plastic side-by-side two component cartridges. In other systems, the two component materials are transported in separate sausage pack containers. The materials must be dispensed by a side-by-side dual chambered dispenser and be connected and dispensed out of a two inlet adapter upon which a mixer may be attached.

In another current system, the two materials are packaged together in a single sausage pack, which includes a pack inside of a pack. These single sausage packs containing two separate materials have an advantage over separated sausage packs because they can be dispensed out of a standard single component sausage pack dispenser. Mixers may be attached to the single component dispenser to mix together the two components as they are being dispensed. The mixers are subject to a streaking phenomenon, which is a tendency to leave streaks of completely unmixed fluid in the extruded mixture.

Thus, an improved and/or simplified dispensing system for dispensing two materials from a single sausage pack is desired to more effectively mix the components during dispensing.

### SUMMARY

The present disclosure provides an improved dispensing system that includes an adapter for use with a single component dispenser to mix two materials being dispensed from a single sausage pack. The adapter assembly is configured to attach to the single component dispenser and to a mixer.

An aspect of the present disclosure provides an adapter. The adapter comprises a cap section, a first outlet, a second outlet, and a coupling member. The cap section has a cap interior surface that defines a cap channel extending therethrough. The first outlet defines a first outlet channel extending therethrough that is in fluid communication with the cap channel. The second outlet defines a second outlet channel extending therethrough that is in fluid communication with the cap channel. The coupling member is configured to couple the adapter to a nozzle.

Another aspect of the present disclosure provides a mixing assembly configured to couple to a single component fluid dispenser. The mixing assembly comprises an adapter and a nozzle. The adapter comprises a cap section, a first outlet, a second outlet, and a coupling member. The cap section has a cap interior surface that defines a cap channel extending therethrough. The first outlet defines a first outlet channel extending therethrough that is in fluid communication with the cap channel. The second outlet defines a second outlet channel extending therethrough that is in fluid communication with the cap channel. The nozzle includes an attachment portion that is configured to engage with the coupling member to secure the nozzle to the adapter.

Another aspect of the present disclosure provides a dispenser, such as a single component dispenser. The single component dispenser includes a fluid container, an adapter, and a nozzle. The adapter is configured to couple to the fluid container. The adapter comprises a cap section, a first outlet, a second outlet, and a coupling member. The cap section has a cap interior surface that defines a cap channel extending therethrough. The first outlet defines a first outlet channel extending therethrough that is in fluid communication with the cap channel. The second outlet defines a second outlet channel extending therethrough that is in fluid communication with the cap channel. The nozzle includes an attachment portion configured to engage with the coupling member to secure the nozzle to the adapter.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there is shown in the drawings illustrative embodiments of the disclosure. It should be understood, however, that the application is not limited to the precise arrangements and instrumentalities shown. In the drawings:

FIG. 1A illustrates an perspective view of a fluid dispenser.

FIG. 1B illustrates an exploded perspective view of the fluid dispenser illustrated in FIG. 1A.

FIGS. 2A and 2B illustrate a front perspective view and a back perspective view of a first aspect of a nozzle.

FIGS. 3A and 3B illustrate a front perspective view and a back perspective view of a first aspect of an adapter assembly.

FIG. 4 illustrates a front perspective view of a second aspect of an adapter assembly.

FIG. 5A illustrates a front perspective view of a third aspect of an adapter assembly.

FIG. 5B illustrates a front perspective view of the third aspect of the adapter assembly illustrated in FIG. 5A with a nozzle coupled thereto.

FIG. 6 illustrates a front perspective view of a fourth aspect of an adapter assembly.

FIG. 7A illustrates a front perspective view of a fifth aspect of an adapter assembly.

FIG. 7B illustrates a front perspective view of the fifth aspect of the adapter assembly illustrated in FIG. 7A with a nozzle coupled thereto.

### DETAILED DESCRIPTION

The disclosure relates generally to a single component fluid dispenser for dispensing two fluids from a single collapsible container (e.g. bag-in-bag 2k pack). The fluid dispensing system includes a container, an adapter (e.g. manifold), and a nozzle (e.g. mixer). The adapter is configured to couple to a distal end of the container such that when the two fluids are being dispensed out of the container they flow through two separate channels within the adapter. As the fluids exit the adapter, they are mixed within the mixer as they flow therethrough.

Certain terminology is used in the description for convenience only and is not limiting. The words “proximal” and “distal” generally refer to positions or directions toward and away from, respectively, an individual operating a fluid dispenser 100. The words “longitudinal”, “radial,” and “transverse” designate directions in the drawings to which reference is made. The term “substantially” is intended to mean considerable in extent or largely but not necessarily wholly that which is specified. The terminology includes the above-listed words, derivatives thereof and words of similar import.

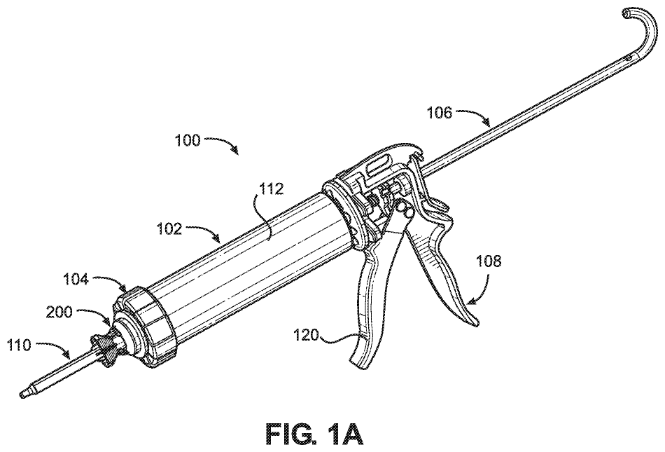

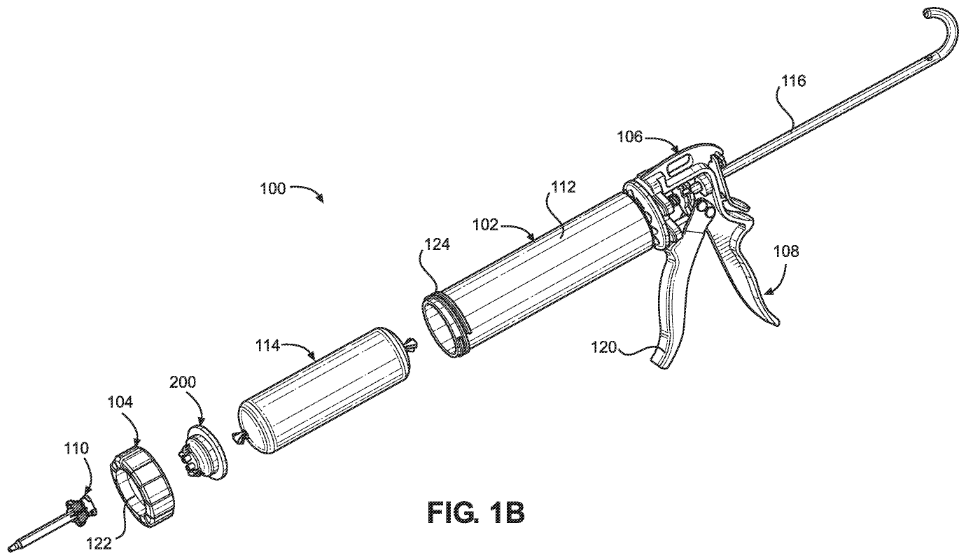

FIGS. 1A and 1B illustrate a collapsed perspective view and an exploded perspective view of the fluid dispenser 100, respectively, according to aspects of this disclosure. The fluid dispenser 100 includes a container sleeve 102, a nut 104, a plunger assembly 106, an actuator 108, a mixer 110 (e.g. nozzle), and an adapter assembly 200. The container sleeve 102 includes a cylindrical barrel 112. The container sleeves 102 may include ribs (not shown) and/or optional retention ribs (not shown) that extend along an outer surface from a distal end to a proximal end of the container sleeve 102. In an aspect, the container sleeve 102 may be configured to be supported by and fit within a support structure (not shown), such that the ribs support the container within the support structure.

The container sleeve 102 is configured to hold a collapsible container 114 within. As used herein, the term “collapsible container” refers to the type of flexible and collapsible fluid containers which are known in the art as “sausage packs.” It will also be appreciated that the collapsible container 114 is also applicable to other types of rigid or flexible containers that have a pierceable component that must be pierced before fluid can be dispensed from the container. The container sleeve 102 may include barrels having varying size diameters, for example, based on varying sizes of collapsible containers 114.

The collapsible container 114 may include a flexible and collapsible, yet resilient, membrane. The membrane is configured to be pierced in order to provide access to the material contained within the membrane. The collapsible containers are generally cylindrical in shape and have a diameter and length slightly less than the container sleeve 102. The collapsible container 114 is a bag-in-bag container configured to hold two materials (e.g. fluids). Each bag within the collapsible container 114 may have a volume similar to a volume of the other bag, or alternatively, the volume of each bag may be different. The volume of each bag within the collapsible container 114 may depend on the types of fluids being dispensed. In some embodiments, the bags may be adjacent to one another in a side-by-side configuration.

The plunger assembly 106 may include a plunger (not visible in figures) and a thrust rod 116. The plunger is configured to slide within the cylindrical barrel 112. The plunger is coupled to a distal end of the corresponding thrust rod 116. The thrust rod 116 extends from a proximal end of the fluid dispenser 100 into the cylindrical barrel 112.

The actuator 108 acts to effect concurrent movement of the thrust rod 116 to advance or retract the plunger. The actuator 108 may be operatively coupled to the thrust rod 116 of the plunger assembly 106, such that actuation of a trigger 120 of the actuator 108 advances the thrust rod 116 in the distal direction. The advancement of the thrust rod 116 causes the plunger to advance into the cylindrical barrel 112. The actuator 108 may comprise a manually driven gun, as shown in the figures, a pneumatically driven gun, or other actuation mechanism configured to drive the plunger.

In an aspect, the fluid dispenser 100 may further include a support structure (not shown). The support structure may include various components, for example, a base, extension arms, and a gate. The support structure is configured to support the container sleeve 102 within the fluid dispenser 100.

The nut 104 is configured to secure the adapter assembly 200 to the container sleeve 102. The nut 104 includes a cylindrical inner surface that defines an inner threaded section 122 thereon, and a channel that extends through the nut 104. The inner threaded section 122 is configured to engage with an outer threaded section 124 on a distal end of the container sleeve 102. The adapter assembly 200 is sized to fit at least partially within the channel of the nut 104 as further described herein.

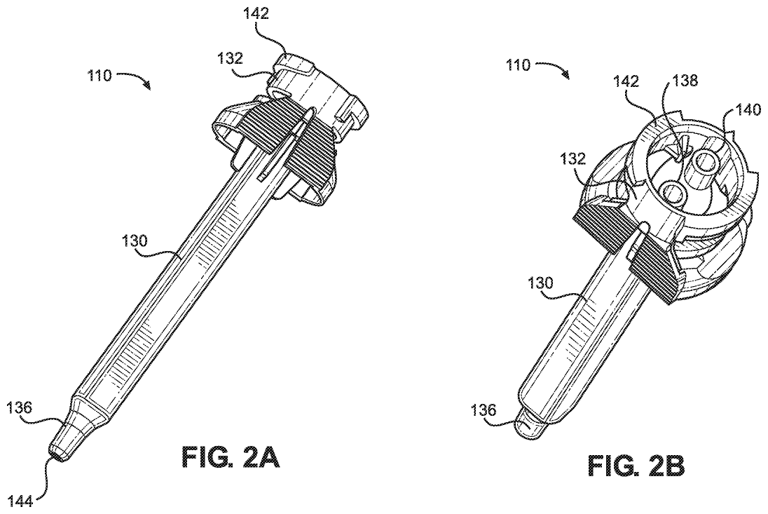

FIGS. 2A and 2B illustrate a front perspective view and a rear perspective view of the mixer 110, respectively, according to aspects of this disclosure. The mixer 110 includes a body 130 having a base 132, a conduit or passage extending through the mixer 110 (not visible in figures), and a tapered dispensing tip 136. The base 132 is configured to engage and attach to the adapter assembly 200. The base 132 includes a first inlet 138, a second inlet 140, and an attachment portion 142 (e.g. bayonet connector). The conduit includes an internal passageway (not visible in figures) that is in fluid communication with each of the first inlet 138 and the second inlet 140. The dispensing tip 136 includes an outlet 144 that is in fluid communication with the internal passageway of the body 130.

The conduit includes a mixing element (not visible in figures) positioned within the internal passageway. The mixing element may include various types of components such as, for example, fins, wedges, webs, plates, bars, baffles, combinations thereof, or other mixing elements. The mixing element may include various types of mixers such as, for example, an inversion mixer, a center of flow redirect mixer, a multiflux mixer, a spiral mixer, an x-mixer, or still other types of mixers.

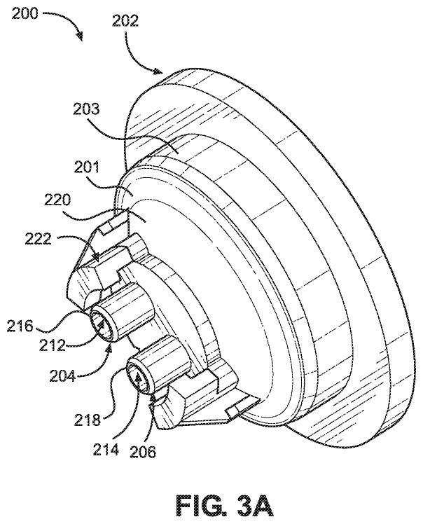

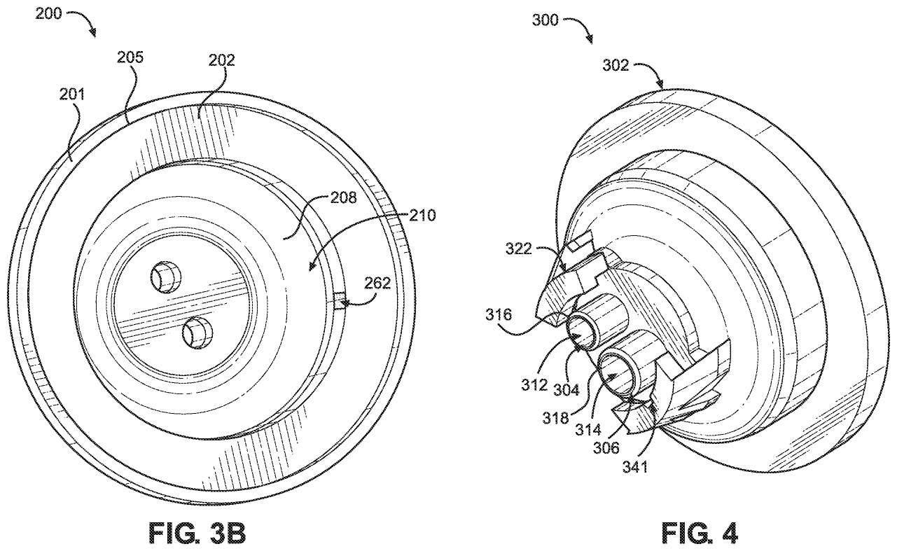

FIGS. 3A and 3B illustrate a front perspective view and a back perspective view of the adapter assembly 200, respectively, according to aspects of this disclosure. The adapter assembly 200 includes a body 201 that has a cap section 202, a first outlet 204, and a second outlet 206. The cap section 202 has a generally tubular shape and is configured to receive a portion of the collapsible container 114 within. A distal end of the collapsible container 114 may be positioned within an opening 205 of the cap section 202. In an aspect, the collapsible container 114 may be adhesively coupled to the adapter assembly 200.

The cap section 202 includes an interior surface 208 that defines a cap channel 210 that extends through the cap section 202 from the opening 205 to the first and second outlets 204 and 206. The cap channel 210 may have a cylindrical shape, tapered shape, combinations thereof, or still other shape.

The first outlet 204 and the second outlet 206 of the adapter assembly 200 are positioned adjacent to one another, and extend away from the cap section 202 to respective distal ends. In an aspect, the first and second outlets 204 and 206 are positioned on either side of and spaced equidistant from a center of the cap section 202. Each of the first and second outlets 204 and 206 include channels 212 and 214 (e.g. bores), respectively. Each channel 212 and 214 extends from the cap channel 210 to a respective opening 216 and 218 at the distal ends.

The adapter assembly 200 further includes a coupling member 222 (e.g. bayonet connector) extending from an outer surface 220. In an aspect, the coupling member 222 extends from a distal end of the adapter assembly 200. The coupling member 222 is configured to engage with attachment portion 142 of the mixer 110 to secure the mixer 110 to the adapter assembly 200. The coupling member 222 may include a threaded seal element, a bayonet seal element, a separated bore seal element, or still other elements configured to engage with the attachment portion 142 to couple the adapter assembly 200 to the mixer 110.

In an aspect, the first and second outlets 204 and 206 are integrally formed with the cap section 202 such that the cap section 202 and the first and second outlets 204 and 206 form a single component. In another aspect, the cap section 202, the first and second outlets 204 and 206, and the coupling member 222 are integrally formed together creating a single integrally formed adapter assembly 200. In another aspect, adapter assembly 200 is integrally formed with the nut 104 to form a single integrally formed adapter assembly 200 that may be directly coupled to the container sleeve 102.

The coupling member 222 and the first outlet 204 and the second outlet 206 of the adapter assembly 200 provide several advantages that include, for example, enabling various types of single seal or separated bore mixers to be sealingly and removably attached and used with standard caulk guns. The adapter assembly 200 enables existing mixers currently on the market to be sealingly and removably attached to a standard single component sausage caulk dispenser.

The adapter assembly 200 may also include a position indicator 262 integrally molded onto the cap section 202. The position indicator 262 is configured to align the body 201 of the adapter assembly 200 with the container sleeve 102 and/or with the collapsible container 114. The position indicator 262 may include a recess, a protrusion, or other configuration that aligns with a corresponding recess, protrusion, or other configuration on the container sleeve 102 and/or collapsible container 114.

The adapter assembly 200 may also include a piercing member (not shown). The piercing member may be coupled to the body 201 of the adapter assembly 200. The piercing member extends into the cap channel 210 of the cap section 202, such that when a collapsible container is positioned within the cap channel 210, the piercing member may engage and pierce the membrane of the container.

In an alternate aspect, the adapter assembly 200 may include multiple piercing members or at least two piercing members (not shown). For example, for a bag-in-bag collapsible container, the adapter assembly 200 may include two piercing members, one piercing member for each bag of the collapsible container.

The use of the fluid dispenser 100 is now described. The fluid dispenser 100 may be provided in a partially disassembled state. For example, the fluid dispenser 100 may be provided with the actuator 108, the plunger assembly 106, and the support structure coupled together, but without the container sleeves 102, nut 104, mixer 110, and adapter assembly 200 coupled thereto. Further, the adapter assembly 200 may not be provided coupled to the container sleeves 102. Additionally, a protective cap (not shown) may be provided to cover the piercing member within the adapter assembly 200. The protective cap may protect the piercing member so that they are not damaged so that, for example, the adapter assembly 200 can be safely sold and transported without concern that the piercing member would damage or be damaged by other components.

When it is desirable to pierce the membranes of the collapsible container 114, the protective cap may be removed from the adapter assembly 200. The collapsible container 114 may be positioned within the container sleeve 102, and the adapter assembly 200 may be positioned at a distal end of the container sleeve 102. The piercing member may pierce the collapsible container 114 within the container sleeve 102. The collapsible container 114 may be provided already glued into position with the adapter assembly 200. Alternatively, the collapsible container 114 may be pierced by a blade, needle, or other sharp object, either before or after being positioned within the container sleeve 102. The adapter assembly 200 is secured to a distal end of the cylindrical barrel 112 by the nut 104. To align the adapter assembly 200 with the cylindrical barrel 112, the position indicator 262 aligns with a corresponding feature on the cylindrical barrel 112. The alignment of the adapter assembly 200 with the cylindrical barrel 112 enables the fluids within the cylindrical barrel 112 to be aligned with the appropriate openings/channels within the adapter assembly 200. The inner threaded section 122 of the nut 104 engages with the outer threaded section 124 of the container sleeve 102, securing the nut 104 to the container sleeve 102. The nut 104 defines an opening through which the neck section 203 of the adapter assembly 200 extends.

The mixer 110 is coupled to the cap section 202 of the adapter assembly 200 by inserting the first inlet 138 and the second inlet 140 of the mixer 110 within the first outlet 204 and the second outlet 206 of the adapter assembly 200, respectively. After the first and second inlets 138 and 140 are inserted, the attachment portion 142 of the base 132 of the mixer 110 is secured to the coupling member 222 extending from the cap section 202 by rotating the mixer 110 relative to the adapter assembly 200. The container sleeve 102 may then be positioned within the support structure, or the container sleeve 102 may be directly coupled to the plunger assembly 106. The collapsible container 114 is secured within the container sleeve 102 between the adapter assembly 200 and the plunger assembly 106.

The actuator 108 is configured to provide a force to the plunger assembly 106 moving the thrust rod 116 in the distal direction forcing the collapsible container 114 to engage the adapter assembly 200. Since the collapsible container 114 is pierced, the fluids contained within the collapsible container 114 can be extracted to flow through the adapter assembly 200 as the force from the thrust rod 116 is applied to the collapsible container 114. In particular, a first fluid within the collapsible container 114 flows through the adapter assembly 200 from the opening 205 to the first opening 216 at the distal end, and a second fluid within the collapsible container 114 flows through the adapter assembly 200 from the opening 205 to the second opening 218 at the distal end.

After the fluids exit the adapter assembly 200 at the distal end, the first and second fluids are introduced into the mixer 110 through the first and second inlets 138 and 140 of the base 132, respectively. The fluids may be further mixed as they flow through the internal passageway of the body 130. The body 130 may include various mixing elements in the internal passageway, for mixing the two fluids in the mixer 110.

The outlet 144 of the dispensing tip 136 fluidly communicates with the internal passageway of the body 130. A composite fluid formed by the mixture of the two fluids created in the mixer 110 flow through the outlet 144 to a point application. Thus, the two fluids from the collapsible container 114 may be discharged from the outlet 144.

While the present aspect has been described in the context of a fluid dispenser 100 having a single collapsible container 114, it will be appreciated that the fluid dispenser 100 may be configured to have multiple collapsible containers each containing fluids to be mixed within the adapter assembly 200 and/or the mixer 110. Regardless of the number of containers, the adapter assembly 200 is configured to include a mixing element within the neck section 203, and further configured to be coupled with one or more containers. The adapter assembly 200 is configured to be attached to the mixer 110 and may include one or more cap sections 202 for receiving one or more collapsible containers.

Although reference is made to the fluid dispenser 100 having the adapter assembly 200 coupled to the mixer 110 in the above described example, it will be appreciated that this method may also be employed by alternative aspects of the fluid dispenser 100 having various aspects of the adapter assembly 200 coupled to various mixers 110 as further described below.

FIG. 4 illustrates a front perspective view of an alternative aspect of an adapter assembly 300. The adapter assembly 300 includes a cap section 302 and a coupling member 322 configured substantially similarly to the cap section 202 and the coupling member 222 of the adapter assembly 200. The adapter assembly 300 further includes a first outlet 304 and the second outlet 306 positioned adjacent to one another, and extending away from the cap section 302 to respective distal ends. Each of the first and second outlets 304 and 306 include outlet channels 312 and 314 (e.g. bores), respectively. Each outlet channel 312 and 314 extends from a cap channel (not visible in figure) to a respective opening 316 and 318 at the distal ends. The adapter assembly 300 may be secured to the container sleeve 102 and the mixer 110 may be secured to the adapter assembly 300 substantially similarly as the adapter assembly 200 is secured to the container sleeve 102 and the mixer 110 as described above.

The adapter assembly 300 is configured to receive two fluids, one within each of the first and second outlet channels 312 and 314. The two fluids flow through the respective first and second openings 316 and 318 into the mixer 110 substantially similarly as the fluids flow through the first and second openings 216 and 218 of the adapter assembly 200. In an aspect, a diameter of the first outlet channel 312 is different from a diameter of the second outlet channel 314. The first inlet 138 and the second inlet 140 of the mixer 110 may have diameters that correspond to the diameters of the first and second outlet channels 312 and 314, respectively.

The coupling member 322 may include a position indicator 341. The position indicator 341 is configured to align the coupling member 322 of the adapter assembly 300 with the mixer 110. The position indicator 341 may include a recess, a protrusion, or other configuration that aligns with a corresponding recess, protrusion, or other configuration on the mixer 110.

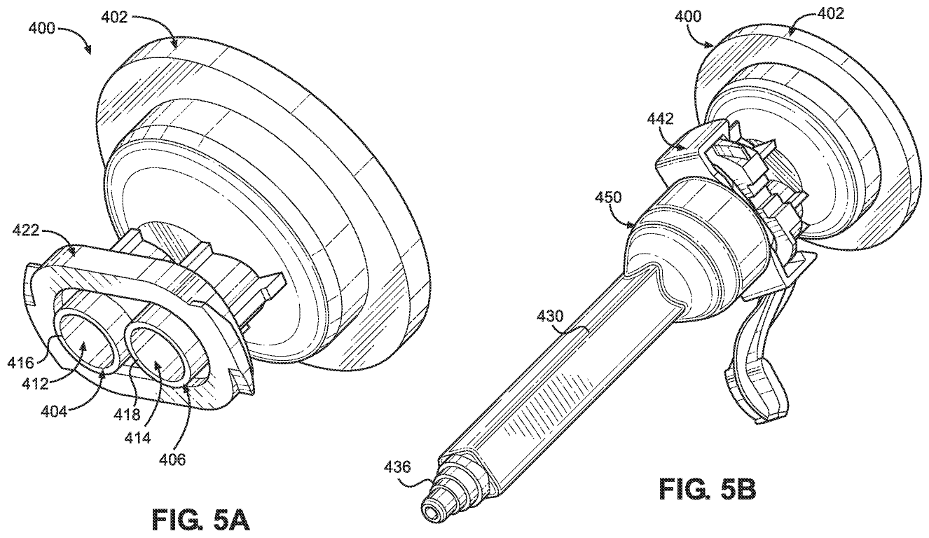

FIG. 5A illustrates a front perspective view of another alternative aspect of an adapter assembly 400. The adapter assembly 400 includes a cap section 402, a first outlet 404, and a second outlet 406 configured substantially similarly to the cap section 202, the first outlet 204, and the second outlet 206 of the adapter assembly 200, respectively. The adapter assembly 400 is configured to receive two fluids, one within each of the first and second outlet channels 412 and 414. The two fluids flow through the respective first and second openings 416 and 418 into a mixer 450 substantially similarly as the fluids flow through the first and second openings 216 and 218 of the adapter assembly 200 and into the mixer 110. The adapter assembly 400 may be secured to the container sleeve 102 substantially similarly as the adapter assembly 200 is secured to the container sleeve 102, as described above.

FIG. 5B illustrates a front perspective view of the adapter assembly 400 with the mixer 450 coupled thereto. The adapter assembly 400 further includes a coupling member 422 (e.g., a snap-clip connector). The coupling member 422 is configured to engage with a corresponding attachment portion 442 of the mixer 450 to secure the mixer 450 to the adapter assembly 400. In an aspect, the coupling member 422 is positioned on at least one of the first outlet 404 and the second outlet 406. The mixer 450 includes a body 430 and a tapered dispensing tip 436 configured substantially similarly as the body 130 and the dispensing tip 136 of the mixer 110.

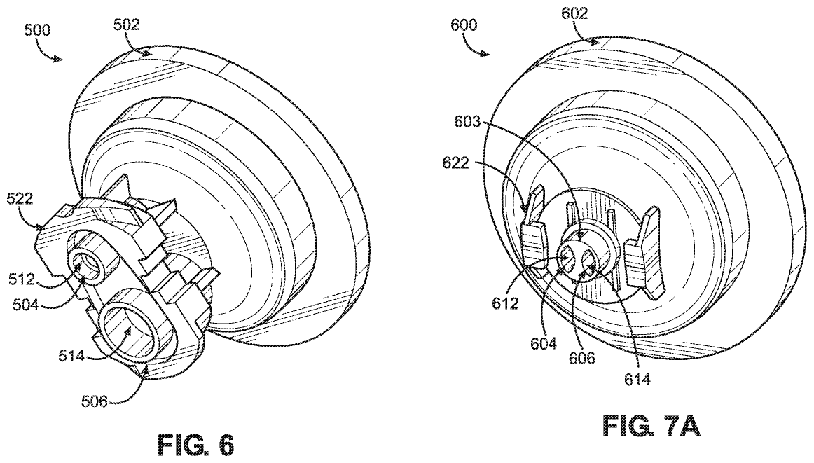

FIG. 6 illustrates a front perspective view of an alternative aspect of an adapter assembly 500. The adapter assembly 500 includes a cap section 502 and a coupling member 522 configured substantially similarly to the cap section 402 and the coupling member 422 of the adapter assembly 400. The adapter assembly 500 further includes a first outlet 504 and the second outlet 506 positioned adjacent to one another, and extending away from the cap section 502 to respective distal ends. The first outlet 504 and the second outlet 506 may be configured substantially similarly as the first outlet 304 and the second outlet 306 of the adapter assembly 300, respectively, such that a diameter of a first outlet channel 512 is different from a diameter of a second outlet channel 514. The adapter assembly 500 may be secured to the container sleeve 102 substantially similarly as the adapter assembly 200 is secured to the container sleeve 102, as described above. The mixer 450 may be secured to the adapter assembly 500 substantially similarly as the mixer 450 is secured to the adapter assembly 400, as described above.

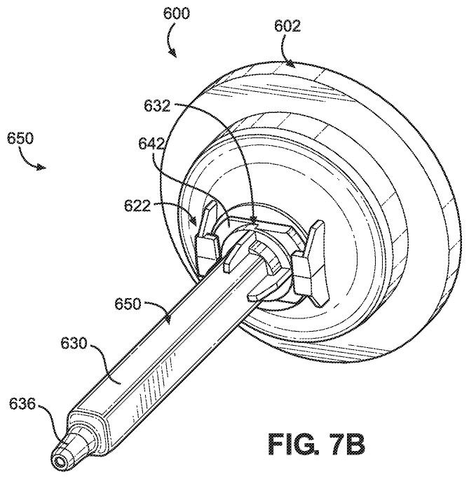

FIG. 7A illustrates a front perspective view of another alternative aspect of an adapter assembly 600. The adapter assembly 600 includes a cap section 602 configured substantially similarly to the cap section 202 of the adapter assembly 200. The adapter assembly 600 further includes a neck section 603 and a coupling member 622. The neck section 603 defines a first outlet 604 and a second outlet 606 that each includes a respective outlet channel 612 and 614 (e.g. bores) that extend through the neck section 603 to a cap channel (not visible in figures). The first outlet 604 and the second outlet 606 are positioned adjacent to one another, and extend away from the cap section 602 to a distal end. In an aspect, the first and second outlets 604 and 606 are positioned on either side of and spaced equidistant from a center of the cap section 602, and the first and second outlets 604 and 606 are substantially symmetric when viewed along a direction extending from the cap channel through a center of the neck section 603. In an alternative aspect, a diameter of the first outlet channel 612 may be different from a diameter of the second outlet channel 614.

The adapter assembly 600 is configured to receive two fluids, one within each of the first and second outlet channels 612 and 614. The two fluids flow through the respective outlet channels 612 and 614 into a mixer 650 coupled to the adapter assembly 600. The adapter assembly 600 may be secured to the container sleeve 102 substantially similarly as the adapter assembly 200 is secured to the container sleeve 102, as described above.

FIG. 7B illustrates a front perspective view of the adapter assembly 600 with the mixer 650 coupled thereto. The coupling member 622 (e.g. bayonet connector) extends from an outer surface of the cap section 602. The coupling member 622 is configured to engage with an attachment portion 642 of the mixer 650 to secure the mixer 650 to the adapter assembly 600. The coupling member 622 may include a threaded seal element, a bayonet seal element, a separated bore seal element, or still other elements configured to engage with the attachment portion 642 to couple the adapter assembly 600 to the mixer 650.

The mixer 650 includes a body 630, a base 632, a conduit or passage extending through the mixer 650 (not visible in figures), and a tapered dispensing tip 636. The base 632 is configured to engage and attach to the adapter assembly 600. The base 632 includes an inlet (e.g. single seal inlet), which is not visible in the figures, and the attachment portion 642 (e.g. bayonet connector). The conduit includes an internal passageway (not visible in figures) that extends from the base 632 to the dispensing tip 636. The dispensing tip 636 includes an outlet that is in fluid communication with the internal passageway of the conduit.

The adapter assembly 600 is configured to receive two fluids within first and second outlet channels 612 and 614 of the neck section 603. After the two fluid flow through the neck section 603, both fluids exit the adapter assembly 600 and enter the internal passageway of the mixer 650 and exits through the outlet of the dispensing tip 636.

The fluid dispenser 100 may be used with various types of collapsible containers. For example, containers that have a pierceable component that must be pierced before fluid can be dispensed from the container (such as syringes, for example) can be used with the adapter assembly 200 in a manner consistent with the above.

Further, in some cases a fluid dispensing assembly, such as the fluid dispenser 100 described above, may be suitable for a single use and will be discarded thereafter, or when its associated collapsible container is empty. In other cases, however, the fluid dispenser 100 may include a mixer and an adapter that are reused with different collapsible containers. For example, after a collapsible container used with a fluid dispensing assembly has been emptied of its fluid contents, it may be removed from the adapter assembly and be replaced by a full collapsible container. As part of replacing the collapsible container, the adapter assembly would be removed from the container so that once a full collapsible container could be placed within the container.

It will be appreciated that the foregoing description provides examples of the disclosed system and method. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

What is claimed is:

1. An adapter configured to couple to a single component fluid dispenser, the adapter comprising:
a cap section having a cap interior surface that defines a cap channel extending therethrough;
a first outlet defining a first outlet channel extending therethrough, the first outlet channel being in fluid communication with the cap channel;
a second outlet defining a second outlet channel extending therethrough, the second outlet channel being in fluid communication with the cap channel; and
a coupling member configured to couple the adapter to a nozzle.

2. The adapter of claim 1, wherein a diameter of the first outlet channel is different from a diameter of the second outlet channel.

3. The adapter of claim 1, wherein the coupling member is positioned on at least one of the first outlet and the second outlet.

4. The adapter of claim 1, wherein the cap section, the first outlet, the second outlet, and the coupling member form a single integrally formed assembly.

5. The adapter of claim 1, wherein the coupling member includes a threaded seal element, a bayonet seal element, or a separated bore seal element.

6. The adapter of claim 1, wherein the cap section includes a position indicator integrally molded thereon, the position indicator configured to align the adapter with the single component fluid dispenser.

7. A mixing assembly configured to couple to a single component fluid dispenser, the mixing assembly comprising:
an adapter comprising:
a cap section having a cap interior surface that defines a cap channel extending therethrough,
a first outlet defining a first outlet channel extending therethrough, the first outlet channel being in fluid communication with the cap channel,
a second outlet defining a second outlet channel extending therethrough, the second outlet channel being in fluid communication with the cap channel, and
a coupling member; and
a nozzle including an attachment portion configured to engage with the coupling member to secure the nozzle to the adapter.

8. The mixing assembly of claim 7, wherein a diameter of the first outlet channel is different from a diameter of the second outlet channel.

9. The mixing assembly of claim 7, wherein the coupling member is positioned on at least one of the first outlet and the second outlet.

10. The mixing assembly of claim 7, wherein the cap section includes a position indicator integrally molded thereon, the position indicator configured to align the adapter with the single component fluid dispenser.

11. The mixing assembly of claim 7, wherein the coupling member includes a threaded seal element, a bayonet seal element, or a separated bore seal element, and wherein the attachment portion of the nozzle includes a threaded seal element, a bayonet seal element, or a separated bore seal element that corresponds to the threaded seal element, the bayonet seal element, or the separated bore seal element of the coupling member.

12. The adapter of claim 7, wherein the nozzle has a first inlet bore and a second inlet bore, and comprises a mixer.

13. A single component fluid dispenser, comprising:
a fluid container;
an adapter configured to couple to the fluid container, the adapter comprising:
a cap section having a cap interior surface that defines a cap channel extending therethrough,
a first outlet defining a first outlet channel extending therethrough, the first outlet channel being in fluid communication with the cap channel,
a second outlet defining a second outlet channel extending therethrough, the second outlet channel being in fluid communication with the cap channel, and
a coupling member; and
a nozzle including an attachment portion configured to engage with the coupling member to secure the nozzle to the adapter.

14. The dispenser of claim 13, further comprising:
a collapsible container configured to contain two fluids, the collapsible container being sized to be positioned within the fluid container.

15. The dispenser of claim 14, further comprising:
a plunger assembly having a single plunger configured to slide within the fluid container to dispense the two fluids contained within the collapsible container.

16. The dispenser of claim 13, wherein a diameter of the first outlet channel is different from a diameter of the second outlet channel.

17. The dispenser of claim 13, wherein the coupling member includes a threaded seal element, a bayonet seal element, or a separated bore seal element, and wherein the attachment portion of the nozzle includes a threaded seal element, a bayonet seal element, or a separated bore seal element that corresponds to the threaded seal element, the bayonet seal element, or the separated bore seal element of the coupling member.

18. The dispenser of claim 13, wherein the cap section includes a position indicator integrally molded thereon, the position indicator configured to align the adapter with the fluid container.

19. The dispenser of claim 13, wherein the nozzle has a first inlet bore and a second inlet bore, and comprises a mixer.

20. The dispenser of claim 13, further comprising a nut configured to secure the adapter to the fluid container.
